(19) United States
(12) Patent Application Publication
(10) Pub. No.: US 2010/0131940 A1
(43) Pub. Date: May 27, 2010

(54) CLOUD BASED SOURCE CODE VERSION CONTROL

(75) Inventor: Charles Paul Jazdzewski, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/323,630

(22) Filed: Nov. 26, 2008

(51) Int. Cl. G06F 9/44

(52) U.S. Cl. 717/170

(57) ABSTRACT

Source code version control is a technique for coordinating source code data and modifications to the source code data between developers. Source code data and/or modifications may be managed as archives. Systems and methods for source code version control operable within a cloud computing environment are disclosed herein. A storage component may be configured to store archive versions deriving from an archive. A root coordinator may be configured to designate a current version of an archive. The root coordinator may change the designation of a current archive upon determining a submitted archive version is a direct successor of a current archive version. If a conflict exists and/or the submitted archive version is not a direct successor, then a reconciler may mechanically resolve conflicts between the submitted archive version and the current archive version to create a reconciled archive version for reconsideration by the root coordinator.

### BACKGROUND

Source code version control is a technique which may be used to manage source code data between developers (e.g., a project comprising source code files in which multiple developers may interact with). Source code version control coordinates modifications made to the source code data. The source code data and/or modifications may be organized into versions of an archive. Within the archive, a version of the source code data may be designated as a current version. Developers may be able to submit a new version of the source code data to the archive. Source code version control may mitigate conflicts between versions and/or other developer's modifications that may arise when designating a new current version of the source code. Developers may also retrieve the current version of the source code data from the archive.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for source code version control is disclosed herein. A storage component is configured to store at least one archive version deriving from an archive (e.g., an archive associated with source code data of a project). The archive version may comprise an archive name corresponding to the archive the archive version derives from; an archive version ID distinctly identifying the archive version; and/or a set of source code data associated with the archive version. The storage component may be configured to receive a request from a user to store a submitted archive version as an archive version within the storage component.

A root coordinator is configured to designate a current archive version stored within the storage component. The root coordinator may store a current archive version ID corresponding to an archive version designated as the current archive version. The root coordinator provides a single source for designating the current version of an archive. The root coordinator may receive a request to change the current archive version ID to correspond to an archive version ID of a submitted archive version. For example, a storage component stores modifications, to a project, submitted by a developer. The developer then requests the root coordinator to designate the new set of source code data, comprising the modifications, as the current version of the project.

Upon receiving the request to change the current version designation, the root coordinator may determine whether the submitted archive version is a direct successor of the current archive version. If the submitted archive version is a direct successor, then the root coordinator changes the current archive version ID to correspond to the archive version ID of the submitted archive version. If the submitted archive version is not a direct successor and/or conflicts between source code files exist, then a reconciler may mechanically resolve the submitted archive version and the current archive version to produce a reconciled archive version. The reconciled archive version may be submitted to the root coordinator for reconsideration.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of source code version control.

FIG. 2 is a flow chart illustrating an exemplary method of source code version control.

FIG. 3 is a component block diagram illustrating an exemplary system for source code version control.

FIG. 4 is an illustration of an example of cloud based source code version control.

FIG. 5 is an illustration of an exemplary computer-readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Source code version control is a common technique used to provide an environment for developers to collaborate together on a project (e.g., a web site project comprising source code files). Developers are able to share changes made to the project with other developers working on the project, while mitigating versioning conflicts which may lead to inoperability of the project due to inter-reliance of files. Source code version control provides a technique for coordinating modifications made to a project and organizing the modifications into an archive comprising versions of the source code data. Two common implementations for source code version control are a traditional client version control and a distributed version control.

A traditional version control approach implements a single server configured to maintain the most current version of a file tree as a file tree archive (e.g., a file tree representing the source code of a project). Clients (e.g., developers) synchronize with the server to obtain the current version of the file tree. Clients may also submit change sets to the server to update the file tree archive, which will either succeed or be rejected. The client machine comprises a workspace for the project. One advantage of the traditional version control approach is that the server is a centralized communication hub that simplifies synchronization. But, the single centralized server lacks scalability and reliability. Reliability becomes an issue because the single centralized server is a single point of failure that may need frequent backup or replication. Because a single server may be configured to handle only a set number of simultaneous users, scalability becomes an issue that is marginally mitigated through proxy servers handling simple tasks.

A distributed version control approach is a multi-master synchronization system. Clients store a copy of the archive on their local computer. Because the clients store a copy of the archive, there is no single point of failure. Change sets are submitted to the local archive, which may be pushed to and/or pulled from other archives. Clients are able to push and pull change sets to the archive from other clients, allowing a sophisticated change set submission workflow. One drawback to the distributed version control is that clients store an entire copy of the archive locally. Another drawback is that there is no natural current version of the archive. The archives have a separate notion of what is the current version. Because the current version is negotiated during push and pulls of change sets, merge conflicts may easily occur after the change set is created.

As set forth herein, cloud based version control is provided based upon a distributed version control model using a single-master synchronization policy. A storage component (e.g., a blob store within a cloud computing environment) may be configured to store an archive corresponding to source code data (e.g., a file tree of source code files associated with a project). The storage component may be configured to store archive versions deriving from the archive. An archive version may comprise an archive name corresponding to the archive the archive version derives from; an archive version ID identifying the archive version; and/or a set of source code data associated with the archive version. An archive version is a separate derivative of the archive, wherein multiple archive versions may be stored within the storage component. Users (e.g., developers) are able to store a submitted archive version within the storage component as an archive version. This storage model provides the benefit of storing distributed versions of an archive in a central location and/or at a user's local computer. It may be appreciated that the storage component may be configured to store the archive and/or archive versions across multiple computing environments within a cloud computing environment.

A root coordinator may be configured to designate a current archive version stored within the storage component. The root coordinator may store an archive version ID of an archive version that is designated as the “current version” of an archive. The root coordinator may be configured to store archive version IDs corresponding to multiple archives within storage components. The root coordinator provides a single source a user may look to for determining the current archive version. It may be appreciated that the root coordinator may execute and/or store the current archive version in a separate location from the storage component. The root coordinator may execute and store the current archive version across multiple computing environments within a cloud computing environment.

The root coordinator may change the designation of the current archive version based upon a request from a user to designate a submitted archive version as the current archive version. The root coordinator may employ a reconciler if conflicts arise in changing the designation (e.g., conflicts arising based upon the submitted archive version not being a direct successor of the current archive version). It may be appreciated that the reconciler may be configured to execute across multiple computing environments within a cloud computing environment, which may be separate from the root coordinator and/or the storage component.

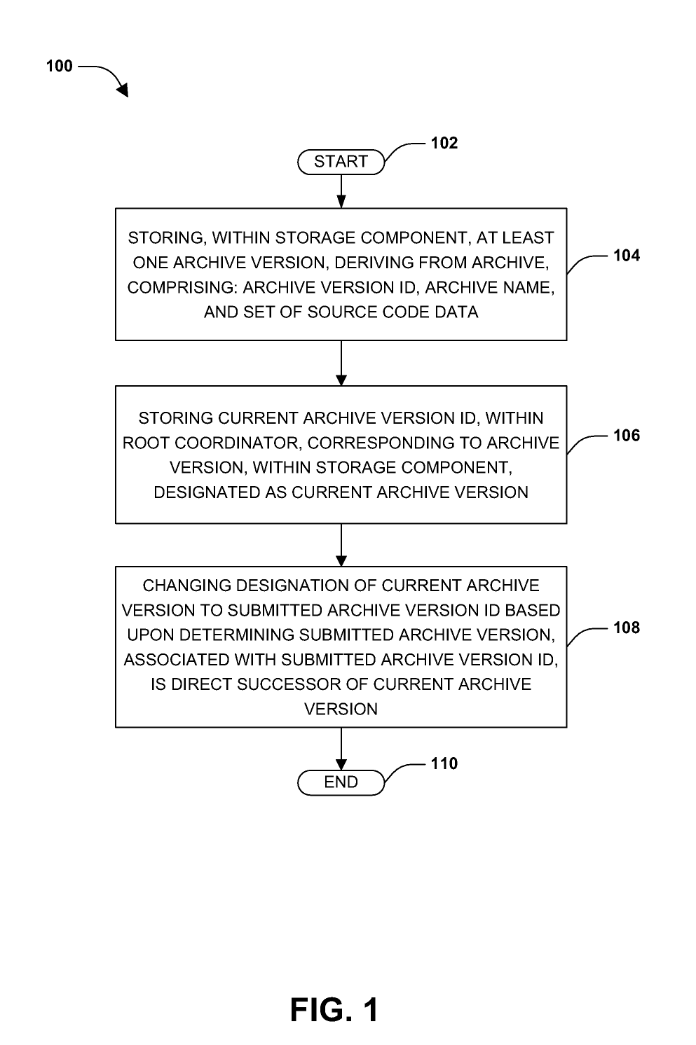

One embodiment of source code version control is illustrated by an exemplary method 100 in FIG. 1. At 102, the method begins. At 104, at least one archive version, deriving from an archive, is stored within a storage component. The storage component may be a blob store residing within a cloud component environment. The storage component may be configured to store multiple archives. An archive version comprises an archive version ID, an archive name, and a set of source code data. Multiple archive versions may be associated with the archive. Once an archive version is stored, the contents of the source code files and the directories of the source code files are constant. The archive version may be stored as a tree structure, wherein a root directory refers to the sub-directories and files. When a file changes within the archive (e.g., a user requests a submitted archive version with modified source code data to be stored), a new archive version is stored.

A user may request the storage component to store a submitted archive version as an archive version of an archive. The submitted archive version may comprise an archive version ID distinct from other archive version IDs associated with archive versions of the archive. The submitted archive version may comprise an archive name corresponding to the archive the submitted archive version derives from. The submitted archive version may comprise a set of source code data. In one example, the set of source code data may comprise a complete set of the source code data corresponding to the archive version. In a second example, the set of source code data may comprise changed source code data with pointers to unchanged source code data within the archive. In a third example, the set of source code data may comprise deltas associated with the changed source code. The user may submit batch changes of the source code data (e.g., a change set) to the storage blob.

At 106, a current archive version ID is stored within a root coordinator. The current archive version ID corresponds to an archive version, designated as a current archive version, within the storage component. The root coordinator is an arbitrator for which archive version within the storage component is considered the “current version” of the archive. Upon receiving a request from a user, the root coordinator may return the current archive version ID to the user. The root coordinator may be configured to store a plurality of current archive version IDs and corresponding archive names, wherein a current archive version ID corresponds to a current archive version of a corresponding archive.

At 108, the designation of the current archive version (e.g., the current archive version ID) is changed to a submitted archive version ID based upon determining a submitted archive version, associated with submitted archive version ID, is a direct successor of the current archive version. The root coordinator may change the designation of the current archive version by changing the current archive version ID. In one example, a user may store a submitted archive version, having a submitted archive version ID, within a storage component. Once the submitted archive version is stored, the user may request that the root coordinator change the current archive version ID to the submitted archive version ID, thus designating the submitted archive version as the “current version” of an archive.

The root coordinator may make a determination as to whether a submitted archive version is a direct successor of the current archive version. If the submitted archive version is a direct successor of the current archive version, then the root coordinator may accept the submitted archive version as the current archive version and change the current archive version ID to correspond to the submitted archive version ID. If a merge conflict occurs (e.g., the submitted archive version is not a direct successor of the current archive version), then the root coordinator may request a reconciler to mechanically resolve the submitted archive version with a current archive version.

The reconciler may create a reconciled archive version by merging the current archive version with the submitted archive version to create a reconciled archive version comprising non-conflicting merged source code files. The reconciler may submit the reconciled archive version to the root coordinator to determine whether the reconciled archive version is a direct successor of the current archive version (e.g., subsequent requests may be processed where the root coordinator designates a new current archive version that the reconciled archive version is not a direct successor of). If the reconciler is unable to resolve the submitted archive version and the current archive version, then the submitted archive version is rejected. At 110, the method ends.

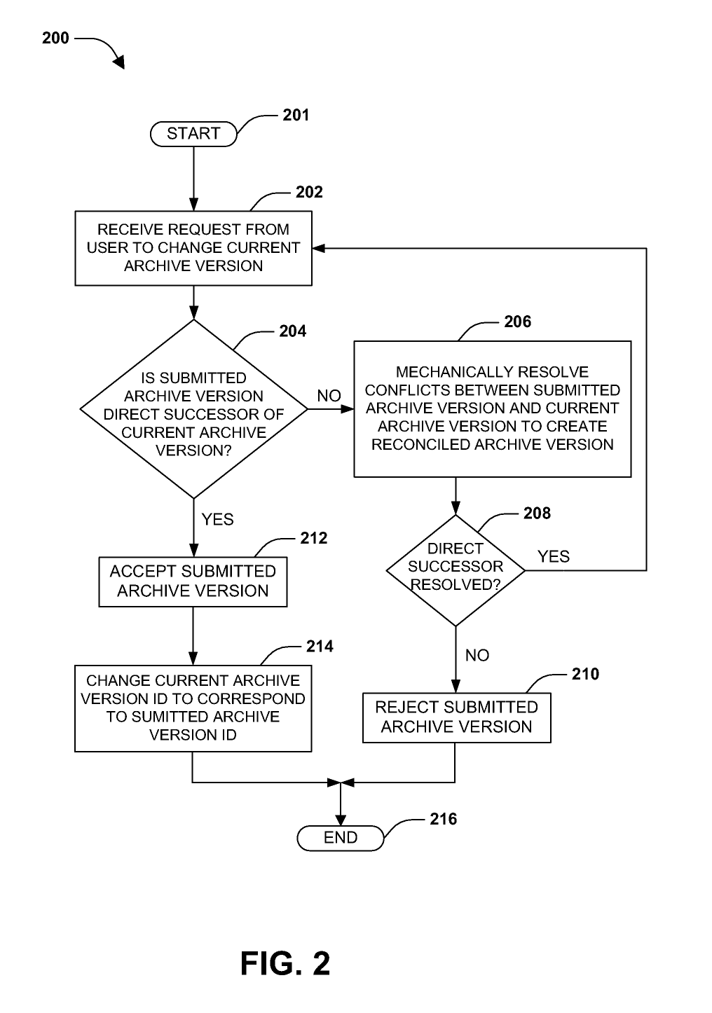

One embodiment of source code version control is illustrated by an exemplary flow diagram 200 in FIG. 2. At 201, the flow diagram starts. At 202, a request to change the current archive version is received from a user. For example, a user may request a root coordinator to change a current archive version ID to correspond to a submitted archive version ID of a submitted archive within a storage component. If the current archive version ID is changed to reflect the submitted archive version ID, then the submitted archive version, within the storage component, will be designated as the “current version” of an archive.

At 204, a determination is made as to whether the submitted archive version is a direct successor of the current archive version. If the submitted archive version is not a direct successor, then a reconciler may mechanically resolve conflicts between the submitted archive version and the current archive version to create a reconciled archive version which may be a direct successor, at 206. At 208, a determination is made as to whether the reconciler was able to create a reconciled archive version which is a direct successor of the current archive version. If the reconciler is unable to resolve conflicts to create a reconciled archive version that is a direct successor, then the request to change the current archive version is rejected, at 210.

If the reconciler is able to create a reconciled archive version that is a direct successor, then the reconciled archive version is resubmitted as a submitted archive version for reconsideration (e.g., at 202). The resubmission from the reconciler may receive priority treatment in comparison to other requests that may be stored within a queue.

If the submitted archive version is a direct successor of a current archive version, then the submitted archive version is accepted, at 212. At 214, the current archive version ID is changed to correspond to the submitted archive version ID. At 216, the flow diagram ends.

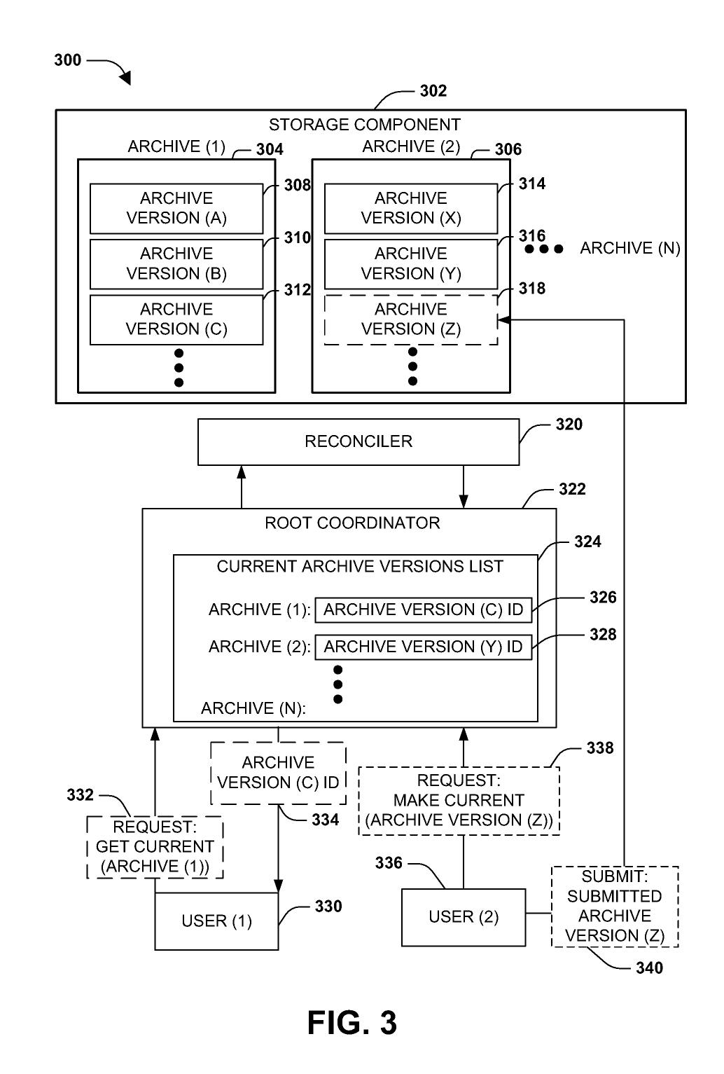

FIG. 3 illustrates an example of a system 300 configured to provide source code version control. The system 300 may be configured to execute within a cloud computing environment. The system 300 comprises a storage component 302, a root coordinator 322, and a reconciler 320. The system 300 may include a locking component configured to lock at least one source code file within a set of source code data. The storage component 302 may be configured to store at least one archive version deriving from an archive. For example, the storage component 302 may store an archive version (A) 308, an archive version (B) 310, and an archive version (C) 312 deriving from an archive (1) 304. The storage component 302 may be configured to store archive versions corresponding to a plurality of archives. For example, storage component 302 may comprise archive versions for the archive (1) 304, archive versions for an archive (2) 306, and archive versions up to an archive (N). It may be appreciated that N may be a positive integer greater than 0, wherein the storage component 302 may store archive versions for a large plurality of archives.

The storage component 302 may be configured to store an archive version comprising an archive version ID corresponding to the archive version (e.g., distinctly identifying the archive version); an archive name corresponding to the archive the archive version derives from; and/or a set of source code data associated with the archive version. For example, a submit request 340 for the storage component 302 to store a submitted archive version (Z) deriving from the archive (2) 306 may be received from a user (2) 336. The storage component may store the submitted archive version (Z) as an archive version (Z) 318. Archive (2) 306 now comprises an archive version (X) 314, an archive version (Y) 316, the archive version (Z) 318, and/or other archive versions.

The root coordinator 322 may be configured to store a current archive versions list 324 comprising at least one current archive version ID, wherein a current archive version ID corresponds to an archive name. For example, a current archive version (C) ID 326 designates a “current version” of the archive (1) 304 as the archive version (C) 312. A current version (Y) ID 328 designates a “current version” of the archive (2) 306 as the archive version (Y) 316. The root coordinator 322 may be configured to receive a request from a user for the “current version” of an archive. For example, a get current request 332 corresponding to archive (1) 304 may be received from a user (1) 330. The root coordinator may determine that the “current version” for archive (1) 304 is archive version (C) 312. The root coordinator may return the archive version (C) ID 326 in a response 334.

The root coordinator 322 may be configured to change the designation of the “current version” of an archive by changing the current archive version ID. For example, the archive version (Y) 316 may be the “current version” of the archive (2) 306. The root coordinator designates the archive version (Y) 316 as the “current version” by storing the archive version (Y) ID 328. The root coordinator 322 may receive a make current request 338 from user (2) 336. The make current request 338 may comprise a request to make the archive version (Z) 318 (e.g., the submitted archive version (Z)) the “current version” of the archive (2) 306. The root coordinator 322 may determine whether archive version (Z) 318 is a direct successor of archive version (Y) 316. If the archive version (Z) 318 is a direct successor, then the root coordinator 322 may designate the archive version (Z) 318 as the current archive version by storing an archive version ID associated with the archive version (Z) 318.

If the archive version (Z) 318 is not a direct successor and/or file conflicts may result, then the root coordinator requests the reconciler 320 to mechanically resolve the archive version (Z) 318 (e.g., the submitted archive version) with the archive version (Y) 316 (e.g., the current archive version) to create a reconciled archive version. The reconciler 320 may be configured with at least one policy for mechanically resolving conflicts between two archive versions. In a first example, the reconciler 320 may determine at least one file that was changed between the archive version (Z) 318 and the archive version (Y) 316. If no changed files are in conflict, then a reconciled archive version is created with the new files from the archive version (Z) 318 and the archive version (Y) 316. In a second example, the reconciler may request external verification that a reconciled archive version is able to be built and passes a series of test. In a third example, a merge operation may be performed on the content of the files to create a reconciled archive version comprising non-conflicting merges.

If a reconciled archive version is created, then it is submitted to the root coordinator 322 to determine whether the reconciled archive version is a direct successor of a current version. If the reconciled archive version is a direct successor, then the reconciled archive version becomes the “current version” of the archive (2) 306.

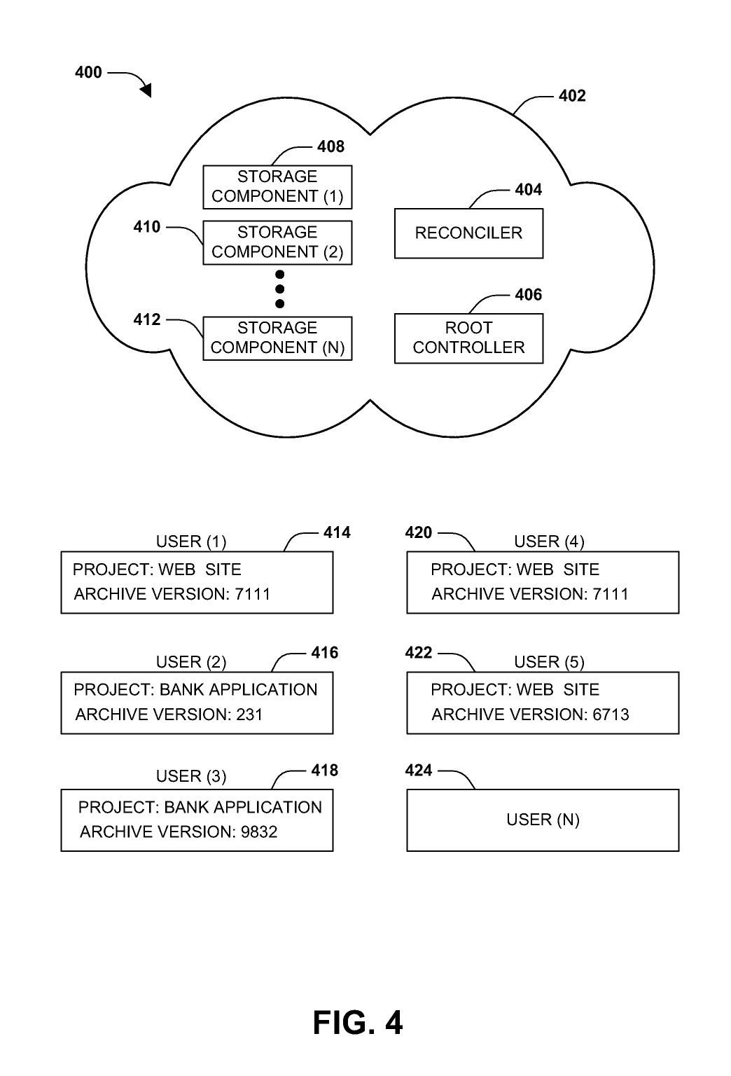

FIG. 4 is an example of a cloud based source code version control system 400. A root coordinator 406, a reconciler 404, and at least one storage component (e.g., a storage component (1) 408, a storage component (2) 410, and up to a storage component (N) 412 where N is an integer greater than 0) may be executed within a cloud computing environment 402. The root coordinator 406, the reconciler 404, and the storage components may span across multiple computing environments. The root coordinator 406 provides an easy to implement single master synchronization system, wherein a user may retrieve a “current version” designation of an archive. The root coordinator 406 provides a definitive “current version” designation, wherein a plurality of versions of an archive may exist within storage components. The storage components may utilize blob storage. Because the blob storage may be highly replicated and scalable, a version of an archive may be stored as a constant set of files. Because of the scalability, a large number of simultaneous users may interact with the cloud based source code version control system 400 (e.g., a user (1) 414, a user (2) 416, a user (3) 418, a user (4) 420, a user (5) 422, and up to a user (N) 424 where N is an integer greater than 0).

In one example of the cloud based source code version control system 400, the root coordinator 406 may comprise a web site current archive version ID corresponding to a web site project archive and a bank application current archive version ID corresponding to a bank application project archive. The storage components may be configured to store a bank application project archive with derivative archive versions and a web site project archive with derivative archive versions. The user (1) 414, user (4) 420, and user (5) 422 may be locally developing source code files for the web site project. The user (1) 414 may be working with a web site archive version ID 7111 of the source code files. The user (4) 420 may be working with a web site archive version ID 7111 of the source code files. The user (5) 422 may be working with a web site archive version ID 6713 of the source code files.

In one example, user (5) 422 may modify source code data associated with the web site project. The user (5) 422 may associate a new web site archive version ID of 8999 with the modified web site project. The user (5) 422 may submit a request to the storage component (1) 408 to store an archive version corresponding to the modified web site project. The storage component (1) 408 may store an archive version comprising the source code data of the modified web site project, the new web site archive version ID of 8999, and/or an archive name associated with the web site project archive. Once an archive version is stored, the user (5) 422 may request the root coordinator 406 to update a “current version” designation for the web site project archive to correspond to the new web site archive version ID of 8999. If no file conflicts exist between the source code data of the new web site archive version and the source code data of the current archive version (e.g., the source code data from user (5) is a direct successor), then the root coordinator 406 may change the current version designation to 8999. If a conflict exists, then the reconciler 404 may be invoked to mechanically resolve a reconciled archive version, which may be resubmitted to the root coordinator 406 for reconsideration.

Because the root coordinator is able to designate “current versions” for multiple archives, the user (2) 416 and the user (3) 418 may also interact with the root coordinator 406 concerning the bank application project. The user (2) 416 and the user (3) 418 may be locally developing source code files for the bank application project. The user (2) 416 may be working with a bank application archive version ID of 231 of the source code files. The user (3) 418 may be working with a bank application archive version ID of 9832 of the source code files. It may be appreciated that a GUID, SHA-256 hash value, and/or any other designation of an archive version ID may be used to designate an archive version.

The cloud based source code version control system 400 may host a large number of projects. Because of scalability, multiple users in excess of ten thousand may interact within the cloud based source code version control system 400 with these projects.

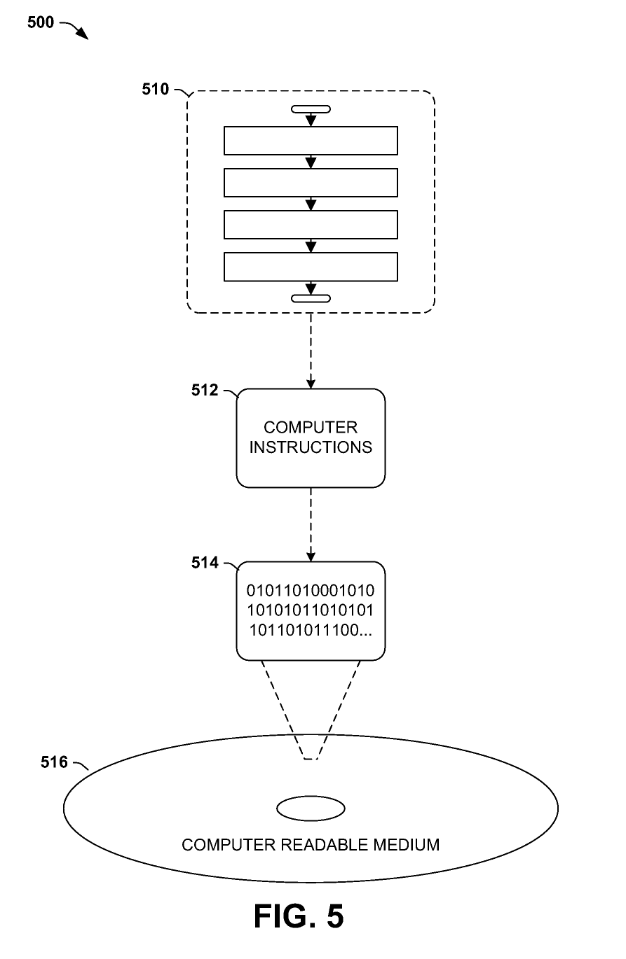

Still another embodiment involves a computer-readable medium comprising processor-executable instructions configured to implement one or more of the techniques presented herein. An exemplary computer-readable medium that may be devised in these ways is illustrated in FIG. 5, wherein the implementation 500 comprises a computer-readable medium 516 (e.g., a CD-R, DVD-R, or a platter of a hard disk drive), on which is encoded computer-readable data 510. This computer-readable data 510 in turn comprises a set of computer instructions 512 configured to operate according to one or more of the principles set forth herein. In one such embodiment 500, the processor-executable instructions 514 may be configured to perform a method, such as the exemplary method 100 of FIG. 1, for example. In another such embodiment, the processor-executable instructions 514 may be configured to implement a system, such as the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

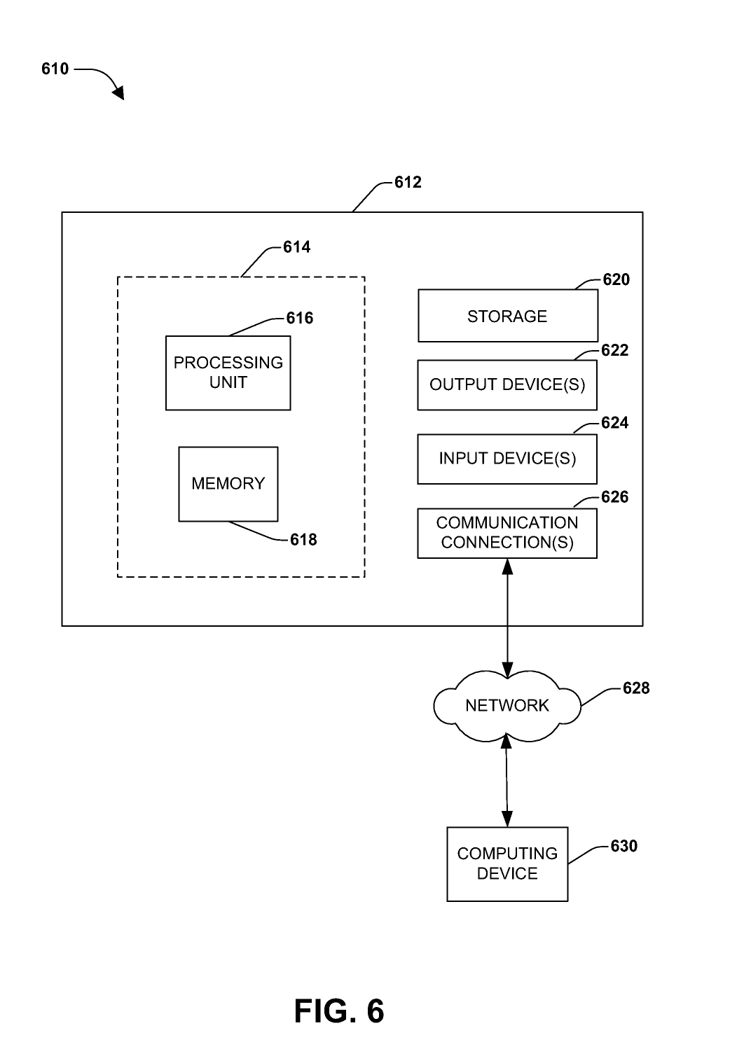

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for source code version control comprising:
a storage component configured to store at least one archive version, deriving from an archive, comprising:
an archive version ID corresponding to the archive version;
an archive name corresponding to the archive; and
a set of source code data associated with the archive version;
a root coordinator configured to designate a current archive version stored within the storage component; and
a reconciler configured to mechanically resolve conflicts between a submitted archive version and a current archive version.

2. The system of claim 1, the root coordinator configured to store at least one archive name comprising a current archive version ID to designate the current archive version within the storage component.

3. The system of claim 2, the root coordinator configured to:
receive a make current request to change the current archive version ID, the make current request comprising a submitted archive version ID corresponding to a submitted archive version within the storage component;
determine whether the submitted archive version is a direct successor of the current archive version; and
upon determining the submitted archive version is a direct successor of the current archive version, store the submitted archive version ID as the current archive version ID to designate the submitted archive version as the current archive version.

4. The system of claim 2, the root coordinator configured to:
receive a make current request to change the current archive version ID, the make current request comprising a submitted archive version ID corresponding to a submitted archive version within the storage component;
determine whether the submitted archive version is a direct successor of the current archive version; and
upon determining the submitted archive version is not a direct successor of the current archive version, requesting the reconciler to resolve conflicts between the submitted archive version and the current archive version to create a reconciled archive version.

5. The system of claim 2, the root coordinator configured to:
receive a request from a user to determine the current archive version; and
send to the user the current archive version ID.

6. The system of claim 1, the storage component configured to:
receive a submitted archive version comprising:
a submitted archive version ID;
an archive name; and
a set of source code data; and
store the submitted archive version as an archive version.

7. The system of claim 1, the reconciler configured to:
queue a request from the root coordinator to create a reconciled archive version based upon a submitted archive version and the current archive version;
create a reconciled archive version based upon mechanical reconciliation of the submitted archive version and the current archive version; and
submit the reconciled archive version to the root coordinator to determine whether the reconciled archive version is a direct successor of the current archive version.

8. The system of claim 1, the storage component configured to store at least one delta comprising changed source code data associated with the archive stored within the storage component.

9. The system of claim 1, the root coordinator configured to store a plurality of archive versions corresponding to a plurality of archives.

10. The system of claim 1, comprising a locking component configured to lock at least one source code file within a set of source code data.

11. The system of claim 1, comprising:
the storage component configured to execute across at least one computing environment within a cloud computing environment;
the root coordinator configured to execute across at least one computing environment within a cloud computing environment; and
the reconciler configured to execute across at least one computing environment within a cloud computing environment.

12. A method for source code version control comprising:
storing, within a storage component, at least one archive version, deriving from an archive, comprising:
an archive version ID corresponding to the archive version;
an archive name corresponding to the archive; and
a set of source code data associated with the archive version;
storing a current archive version ID, within a root coordinator, corresponding to an archive version, within the storage component, designated as the current archive version; and
changing the designation of the current archive version to a submitted archive version ID based upon determining a submitted archive version, associated with the submitted archive version ID, is a direct successor of the current archive version.

13. The method of claim 12, comprising:
creating a reconciled archive version based upon mechanically resolving a submitted archive version and a current archive version; and
submitting the reconciled archive version to the root coordinator for determination whether the reconciled archive version is a direct successor of a current archive version.

14. The method of claim 13, the creating a reconciled archive version comprising at least one of:
merging the submitted archive version with the current archive version to produce the reconciled archive version comprising non-conflicting merged source code files; and
rejecting the submitted archive version as irresolvable based upon a conflict of at least one source code file between the submitted archive version and the current archive version.

15. The method of claim 12, comprising:
storing at least one delta comprising changed source code data associated with the archive within the storage component.

16. The method of claim 12, comprising:
receiving a get current request from a user; and
returning the current archive version ID, stored within the root coordinator, to the user.

17. The method of claim 12, comprising:
storing at least one archive name associated with an archive stored within the storage component; and
storing at least one current archive version ID, wherein a current archive version ID is associated with an archive name.

18. The method of claim 12, comprising:
storing the at least one archive version across at least one computing environment within a cloud computing environment; and
storing the current archive version ID across at least one computing environment within a cloud computing environment.

19. The method of claim 12, comprising:
executing the storage component across at least one computing environment within a cloud computing environment;
executing the root coordinator across at least one computing environment within a cloud computing environment; and
executing the reconciler across at least one computing environment within a cloud computing environment.

20. A system for cloud based source code version control comprising:
a storage component configured to execute across at least one computing environment within a cloud computing environment, the storage component configured to:
store at least one archive version, deriving from an archive, comprising:
an archive version ID corresponding to the archive version;
an archive name corresponding to the archive; and
a set of source code data associated with the archive version;
a root coordinator configured to execute across at least one computing environment within a cloud computing environment, the root coordinator configured to:
store a current archive version ID, corresponding to an archive version stored within the storage component, to designate a current version of an archive;
update the current archive version ID based upon determining a submitted archive version is a direct successor of the current version of the archive;
update the current archive version ID based upon determining a reconciled archive version is a direct successor of the current version of the archive; and
request a reconciler to create a reconciled archive version based upon the submitted archive version, that is not a direct successor, and the current version of the archive; and
the reconciler configured to execute across at least one computing environment within a cloud computing environment, the reconciler configured to:
mechanically resolve conflicts between the submitted archive version and the current version of the archive to create the reconciled archive version.
